(19) United States
(12) Patent Application Publication
(10) Pub. No.: US 2019/0367003 A1
(43) Pub. Date: Dec. 5, 2019

(54) CONTROL DEVICE FOR VEHICLE

(71) Applicant: Honda Motor Co.,Ltd., Tokyo (JP)

(72) Inventors: Yuki OKADA, Saitama (JP); Kazunori MIYATA, Saitama (JP); Kyohei SAKAGAMI, Saitama (JP); Kiyoshi WAKAMATSU, Saitama (JP)

(73) Assignee: Honda Motor Co.,Ltd., Tokyo (JP)

(21) Appl. No.: 16/423,186

(22) Filed: May 28, 2019

(30) Foreign Application Priority Data
May 31, 2018 (JP) 2018-105710

(51) Int. Cl. B60W 10/20; B60W 30/18; B60W 40/114; B60W 40/06; B60W 50/14; B60W 30/182; B60W 50/08; B60W 50/12; B60T 8/1755

(52) U.S. Cl. CPC B60W 10/20; B60W 30/18163; B60W 40/114; B60W 40/06; B60W 50/14; B60W 30/182; B60W 2420/52; B60W 50/12; B60T 8/1755; B60W 2710/20; B60W 2550/402; B60W 2420/42; B60W 50/087

(57) ABSTRACT

The control device for a vehicle (1) includes a driving force distribution control part (250, 210) that controls distribution of a driving force from a drive source (203) to wheels (Wf1, Wf2, Wr1, Wr2). The control device for the vehicle includes a road surface information acquisition part (12) acquiring road surface information ahead in a traveling direction of the vehicle (1); and a rut determination part (150) performing rut determination to determine whether a rut is present on a road surface ahead in the traveling direction of the vehicle based on the road surface information acquired by the road surface information acquisition part (12). The driving force distribution control part (250, 210) performs control to change distribution of the driving force to the wheels (Wf1, Wf2, Wr1, Wr2) when determination made by the rut determination part (150) changes between that a rut is present and that no rut is present.

### CROSS-REFERENCE TO RELATED APPLICATION

This application claims the priority benefit of Japan application serial no. 2018-105710, filed on May 31, 2018. The entirety of the above-mentioned patent application is hereby incorporated by reference herein and made a part of this specification.

### BACKGROUND

### Technical Field

The disclosure relates to a control device for a vehicle, and particularly relates to a control device for a vehicle, which includes a driving force distribution control part that controls distribution of a driving force from a drive source for a plurality of wheels.

### Description of Related Art

As disclosed in Patent Document 1, for example, there is a conventional control device for a vehicle, which includes an automatic driving control part that automatically controls at least one of acceleration, deceleration, and steering of the own vehicle for the own vehicle to travel along a route to the destination.

In the automatic driving control as described above, when there is a rut on the road surface where the vehicle is traveling, the vehicle may change the course by making a left turn, a right turn, etc. from the state of traveling along the rut according to the traveling route of the vehicle, and in that case, the vehicle gets off the rut. In such a case, the vehicle needs to get over (the edge of) the rut when getting off the rut. Particularly, for a vehicle that has a function of controlling distribution of the driving force from the drive source for each wheel, if the driving force is not properly distributed for each wheel when the vehicle gets over the rut, the vehicle may not be able to smoothly get over the rut, and the good traveling performance of the vehicle may be affected. In particular, when the rut is formed on a snowy road surface, since the vehicle may get off the rut often as the course changes, it is desirable to optimize the driving force distribution at the time. The above-mentioned problem may occur not only when the vehicle gets off a rut from the state of traveling along the rut, but also when the vehicle enters a rut from the state of traveling without a rut. Furthermore, the above-mentioned problem does not only happen to automatic driving control, and a similar problem may occur when the vehicle is driven manually.

Regarding the traveling of a vehicle with respect to a rut, Patent Document 2 has disclosed a vehicle automatic steering device that detects a rut on the road so as to avoid the rut when traveling. Furthermore, Patent Document 3 has disclosed a vehicle control device having a function that when a rut is detected at the internal side of a curve, a target vehicle behavior amount is corrected for the inner wheels of the vehicle to travel on the detected rut at the internal side of the curve.

However, none of the above patent documents has disclosure related to controlling distribution of the driving force for each wheel when the vehicle traveling along a rut gets off the rut due to a change in course or when the vehicle enters a rut.

### RELATED ART

### Patent Document

### [Patent Document 1] Japanese Laid-open No. 2017-146819

### [Patent Document 2] Japanese Laid-open No. 2001-260921

### [Patent Document 3] Japanese Laid-open No. 2014-184747

### SUMMARY

In view of the above, the disclosure provides a control device for a vehicle, which makes it possible to smoothly get over a rut when getting off the rut or entering the rut and to secure good traveling performance of the vehicle.

In view of the above, a control device for a vehicle 1 according to the disclosure includes a driving force distribution control part 250, 210 that controls a distribution of a driving force from a drive source 203 to a plurality of wheels Wf1, Wf2, Wr1, Wr2. The control device for the vehicle includes: a road surface information acquisition part 12 acquiring a road surface information ahead in a traveling direction of the vehicle 1; and a rut determination part 150 performing a rut determination to determine whether a rut is present on a road surface ahead in the traveling direction of the vehicle 1 based on the road surface information acquired by the road surface information acquisition part 12, wherein the driving force distribution control part 250, 210 performs a control to change the distribution of the driving force to the wheels Wf1, Wf2, Wr1, Wr2 when the determination made by the rut determination part 150 changes between that a rut is present and that no rut is present.

According to the control device for the vehicle of the disclosure, when the determination made by the rut determination part changes between that a rut is present and that no rut is present, the driving force distribution control part performs control to change the distribution of the driving force to the wheels. Thereby, when the vehicle gets off a rut in a state of traveling along the rut or when the vehicle enters a rut from outside, the driving force can be properly distributed to each wheel for the vehicle to smoothly get over the rut, and it is possible to secure good traveling performance of the vehicle.

Moreover, in the control device for the vehicle, a direction indicator 84 may be provided, by which the traveling direction of the vehicle is indicated by an operation of a driver of the vehicle 1, wherein the rut determination part 150 performs the rut determination based on the operation of the direction indicator 84 performed by the driver.

According to this configuration, the rut determination part can grasp the traveling direction of the vehicle in advance by performing rut determination based on the operation of the direction indicator performed by the driver, and it is possible to accurately determine whether a rut is present on the road surface ahead in the traveling direction. Therefore, it is possible to get over a rut more smoothly.

In addition, in the control device for the vehicle, a navigation device 13a may be provided, which has a function of acquiring information from outside to identify a position of the vehicle 1 and deriving a route from the position to a destination, wherein the rut determination part 150 performs the rut determination based on a traveling route of the vehicle 1 derived by the navigation device 13a.

According to this configuration, the rut determination part can grasp the traveling direction of the vehicle in advance by performing rut determination based on the traveling route of the vehicle derived by the navigation device, and it is possible to accurately determine whether a rut is present on the road surface ahead in the traveling direction. Therefore, it is possible to get over a rut more smoothly.

Furthermore, in the control device for the vehicle, an automatic driving control part 110 may be provided, which performs an automatic driving control that automatically controls at least one of acceleration, deceleration, and steering of the vehicle 1, wherein the rut determination part 150 performs the rut determination based on a traveling route of the vehicle 1 determined by the automatic driving control part 110.

According to this configuration, the rut determination part can grasp the traveling direction of the vehicle in advance by performing rut determination based on the traveling route of the vehicle determined by the automatic driving control part, and it is possible to accurately determine whether a rut is present on the road surface ahead in the traveling direction. Therefore, it is possible to get over a rut more smoothly.

Also, in the control device for the vehicle, the driving force distribution control part 250, 210 is capable of switching the distribution of the driving force of the vehicle 1 between a two-wheel drive state and a four-wheel drive state, and when the determination made by the rut determination part 150 changes between that a rut is present and that no rut is present, control may be performed to switch the distribution of the driving force between the two-wheel drive state and the four-wheel drive state.

According to this configuration, control is performed to switch the distribution of the driving force between the two-wheel drive state and the four-wheel drive state when the determination made by the rut determination part changes between that a rut is present and that no rut is present. Thereby, it is possible to secure the driving force required for the vehicle to get over the rut.

In addition, in the control device for the vehicle, the road surface information acquisition part 12 may include an imaging device that captures an image of the road surface ahead in the traveling direction of the vehicle 1, and the rut determination part 150 performs the rut determination based on the image captured by the imaging device.

According to this configuration, the rut determination part performs the rut determination based on the image captured by the imaging device, by which it is possible to more accurately determine whether a rut is present. Therefore, it is possible to get over the rut more smoothly and to secure good traveling performance of the vehicle. The reference numerals in parentheses above indicate drawing reference numerals of the corresponding components in the embodiments described later for reference.

The control device for a vehicle according to the disclosure makes it possible to smoothly get over a rut and to secure good traveling performance of the vehicle.

### BRIEF DESCRIPTION OF THE DRAWINGS

FIG. 1 is a functional configuration diagram of the control device for a vehicle, which is an embodiment of the disclosure.

FIG. 2 is a schematic diagram showing a configuration of the driving device for a vehicle.

FIG. 3 is a block diagram showing a functional configuration of the rut traveling control device.

FIG. 4 is a flowchart for illustrating a procedure of the rut traveling control.

FIG. 5 is a timing chart showing the change of each value in the rut traveling control.

### DESCRIPTION OF THE EMBODIMENTS

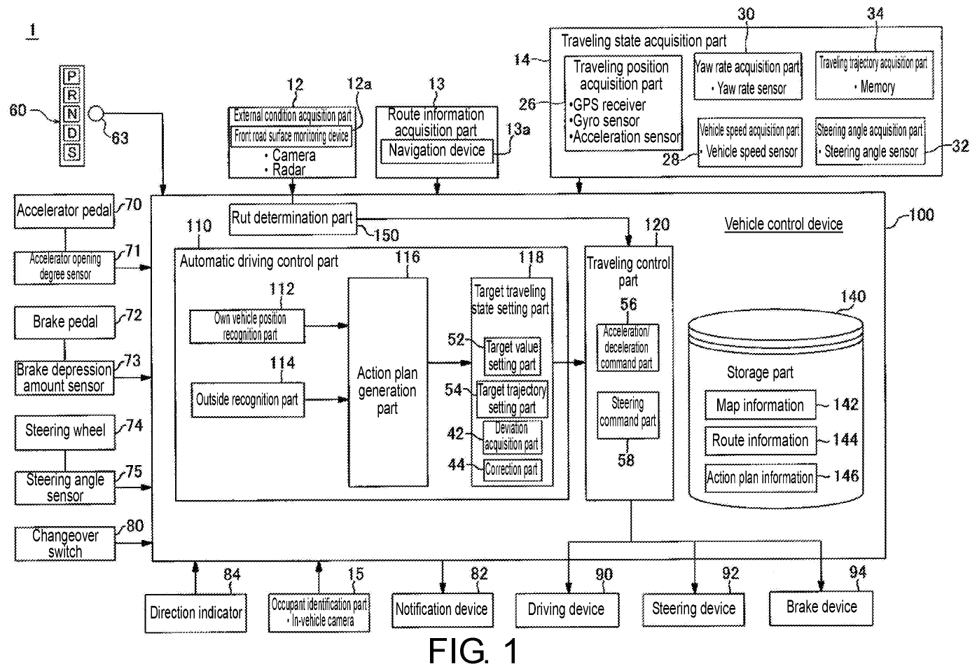

Embodiments of the disclosure will be described below with reference to the accompanying drawings. FIG. 1 is a functional configuration diagram of a control device 100 mounted on a vehicle 1. A configuration of the control device 100 will be described with reference to FIG. 1. The vehicle 1 on which the control device 100 is mounted is a four-wheeled automobile, for example, and includes an automobile powered by an internal combustion engine such as a diesel engine or a gasoline engine, an electric automobile powered by an electric motor, a hybrid automobile having both an internal combustion engine and an electric motor, and the like. Further, the above-mentioned electric automobile is driven using electric power discharged by a battery such as a secondary battery, a hydrogen fuel cell, a metal fuel cell, and an alcohol fuel cell.

The control device 100 includes means for taking in various types of information from the outside of the vehicle 1, such as an external condition acquisition part 12, a route information acquisition part 13, a traveling state acquisition part 14, etc. The control device 100 also includes operation devices such as an accelerator pedal 70, a brake pedal 72, a steering wheel 74, a changeover switch 80, etc., operation detection sensors such as an accelerator opening degree sensor 71, a brake depression amount sensor (brake switch) 73, a steering angle sensor (or a steering torque sensor) 75, etc., a notification device (output part) 82, and an occupant identification part (in-vehicle camera) 15. Further, a driving device 90, a steering device 92, and a brake device 94 are provided as devices for driving or steering the vehicle 1, and the control device 100 is provided for controlling them. These devices and machines are connected to one another by using CAN (controller area network) communication lines such as multiple communication lines or serial communication lines, through a wireless communication network, or the like. Nevertheless, the illustrated operation devices are merely examples, and buttons, dial switches, GUI (graphical user interface) switches, or the like may be mounted on the vehicle 1.

The external condition acquisition part 12 is configured to acquire the external condition of the vehicle 1, for example, environment information of the surroundings of the vehicle such as the lane of the traveled road and objects around the vehicle. The external condition acquisition part 12 includes, for example, various cameras (monocular camera, stereo camera, infrared camera, etc.), various radars (millimeter wave radar, microwave radar, laser radar, etc.), etc. It is also possible to use a fusion sensor that integrates the information obtained by the cameras and the information obtained by the radars.

Moreover, the external condition acquisition part 12 has a front road surface monitoring device 12a for monitoring the road surface ahead in the traveling direction of the vehicle 1. That is, the front road surface monitoring device 12a detects the road surface condition ahead in a direction along the traveling direction (forward direction or reverse direction) of the vehicle 1. The front road surface monitoring device 12a may be provided with an imaging device such as a CCD camera, a millimeter wave radar, a radar using a laser or an infrared ray, a sonar using audible range sound waves or ultrasonic waves, etc., for example. In the case where the front road surface monitoring device 12a is provided with an imaging device such as a CCD camera, the front road surface monitoring device 12a may be further provided with an image recognition device or the like that detects the road surface condition ahead in the traveling direction of the vehicle 1 by analyzing the image data obtained by imaging the front in the traveling direction of the vehicle 1.

The front road surface monitoring device 12a can detect the presence and state of a rut on the road surface in addition to the shape (such as straight and curved) of the road on which the vehicle 1 travels and the traveled lane, as the road surface condition ahead in the traveling direction of the vehicle 1. The rut mentioned here is a trace or depression formed by the wheels of the vehicle that travels on the road surface. For example, the rut includes a trace or depression of wheels formed on a road where snow is piled up. The rut also includes a trace or depression of wheels scraped by friction as vehicles such as large vehicles travel many times over an asphalt or concrete pavement road. Besides, the rut also includes a trace or depression of wheels formed on a gravel road or a soil road.

A rut is detected by the front road surface monitoring device 12a by the following method, for example. For example, the radar of the front road surface monitoring device 12a irradiates and scans a predetermined range of the road surface ahead of the vehicle 1 to the left and right with a laser light in a predetermined distance. Thereby, a transverse line of the laser light reflected by the road surface ahead of the vehicle 1 in the predetermined distance is captured in an image of the front road taken by the camera of the front road surface monitoring device 12a. Here, if the road surface is flat and has no rut, the reflected light of the laser light is observed as a straight transverse line. On the other hand, if there is a rut on the road surface, the transverse line of the laser reflected light is curved or discontinuous at the rut portion. In this manner, the front road surface monitoring device 12a can detect whether a rut is present. Nevertheless, the specific method of detecting a rut is not limited to the above, and other methods may be used. For example, it is also possible to determine only based on the image captured by an imaging device such as a CCD camera.

The route information acquisition part 13 includes a navigation device 13a. The navigation device 13a has a GNSS (global navigation satellite system) receiver or map information (navigation map), a touch panel display device functioning as a user interface, a speaker, a microphone, etc. The navigation device identifies the position of the vehicle 1 by the GNSS receiver and derives a route from the position to the destination designated by the user. The route derived by the navigation device 13a is stored in the storage part 140 as route information 144. The position of the vehicle 1 may be identified or supplemented by INS (inertial navigation system) using the output of the traveling state acquisition part 14. In addition, when the control device 100 is executing a manual driving mode, the navigation device 13a guides the driver along the route to the destination by voice or navigation display. The configuration for identifying the position of the vehicle 1 may be provided independently of the navigation device 13a. Further, the navigation device 13a may be realized by a function of a terminal device such as a smartphone or a tablet terminal held by the user, for example. In that case, information is exchanged between the terminal device and the control device 100 by wireless or wired communication.

The traveling state acquisition part 14 is configured to acquire the current traveling state of the vehicle 1. The traveling state acquisition part 14 includes a traveling position acquisition part 26, a vehicle speed acquisition part 28, a yaw rate acquisition part 30, a steering angle acquisition part 32, and a traveling trajectory acquisition part 34.

The traveling position acquisition part 26 is configured to acquire the traveling position of the vehicle 1 and the attitude (traveling direction) of the vehicle 1, which are one of the traveling states. For example, the traveling position acquisition part 26 includes various positioning devices such as devices (GPS receiver, GNSS receiver, beacon receiver, etc.) that receive electromagnetic waves transmitted from a satellite or a road device to acquire position information (latitude, longitude, altitude, coordinates, etc.), a gyro sensor, an acceleration sensor, or the like. The traveling position of the vehicle 1 is measured with reference to a specific part of the vehicle 1.

The vehicle speed acquisition part 28 is configured to acquire the speed (referred to as the vehicle speed) of the vehicle 1, which is one of the traveling states. For example, the vehicle speed acquisition part 28 includes a speed sensor or the like provided on one or more wheels.

The yaw rate acquisition part 30 is configured to acquire the yaw rate of the vehicle 1, which is one of the traveling states. For example, the yaw rate acquisition part 30 includes a yaw rate sensor or the like.

The steering angle acquisition part 32 is configured to acquire the steering angle, which is one of the traveling states. For example, the steering angle acquisition part 32 includes a steering angle sensor provided on a steering shaft. Here, the steering angle speed and steering angle acceleration are also acquired based on the acquired steering angle.

The traveling trajectory acquisition part 34 is configured to acquire information of the actual traveling trajectory of the vehicle 1, which is one of the traveling states. The actual traveling trajectory includes the trajectory (locus) actually traveled by the vehicle 1 and may include a trajectory planned to be traveled from now on, for example, an extended line on the front side in the traveling direction of the traveled trajectory (locus). The traveling trajectory acquisition part 34 includes a memory. The memory stores position information of a series of point sequences included in the actual traveling trajectory. Moreover, the extended line can be predicted by a computer or the like.

The accelerator opening degree sensor 71, the brake depression amount sensor 73, and the steering angle sensor 75 which are the operation detection sensors output the accelerator opening degree, the brake depression amount, and the steering angle as detection results to the control device 100.

The changeover switch 80 is a switch operated by an occupant of the vehicle 1. The changeover switch 80 accepts the operation of the occupant and switches the driving mode (for example, automatic driving mode and manual driving mode) from the accepted operation content. For example, the changeover switch 80 generates a driving mode designation signal for designating the driving mode of the vehicle 1 from the operation content of the occupant, and outputs the driving mode designation signal to the control device 100.

Further, the vehicle 1 of the present embodiment includes a shift device 60 operated by the driver via a shift lever. The positions of the shift lever (not shown) in the shift device 60 include P (parking), R (reverse traveling), N (neutral), D (forward traveling in automatic shift mode (normal mode)), S (forward traveling in sports mode), or the like, as shown in FIG. 1, for example. A shift position sensor 63 is provided near the shift device 60. The shift position sensor 63 detects the position of the shift lever operated by the driver. Information of the shift position detected by the shift position sensor 63 is inputted to the control device 100. In the manual driving mode, the information of the shift position detected by the shift position sensor 63 is directly outputted to the driving device 90 (AT-ECU 242).

The notification device 82 includes various devices that can output information. The notification device 82 outputs information for urging the occupant of the vehicle 1 to shift from the automatic driving mode to the manual driving mode, for example. For example, at least one of a speaker, a vibrator, a display device, a light emitting device, or the like is used as the notification device 82.

The occupant identification part 15 includes an in-vehicle camera that can image the interior of the vehicle 1, for example. For example, the in-vehicle camera may be a digital camera using a solid-state imaging element such as CCD or CMOS, a near infrared camera combined with a near infrared light source, or the like. The control device 100 can acquire the image photographed by the in-vehicle camera and identify the current driver of the vehicle 1 from the image of the face of the driver of the vehicle 1 included in the image.

The vehicle 1 also includes a direction indicator (blinker) 84. Although detailed illustration is omitted, the direction indicator 84 has a direction indicating lamp on the left side (left turning direction) or the right side (right turning direction), an operation lever for blinking the direction indicating lamp, and a driving circuit (not shown) of the direction indicating lamp. In the direction indicator 84, when the traveling mode of the vehicle is the manual driving mode, the direction indicating lamp in the direction instructed by the operation of the operation lever performed by the driver blinks.

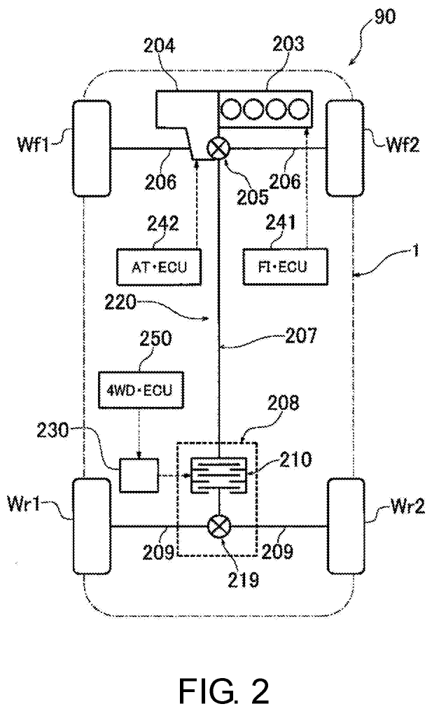

In the vehicle 1 of the present embodiment, as shown in FIG. 2, the driving device 90 includes an engine 203 serving as the drive source, an FI-ECU (electronic control unit) 241 for controlling the engine 203, an automatic transmission 204, and an AT-ECU 242 for controlling the automatic transmission 204. In addition to the above, in the case where the vehicle 1 is an electric automobile using an electric motor as the power source, the driving device 90 may include a traveling motor and a motor ECU for controlling the traveling motor. In the case where the vehicle 1 is a hybrid automobile, it may include an engine, an engine ECU, a traveling motor, and a motor ECU. In the case where the driving device 90 includes the engine 203 and the automatic transmission 204, as in the present embodiment, the FI-ECU 241 and the AT-ECU 242 control the throttle opening degree of the engine 203, the shift stage of the automatic transmission 204, or the like according to the information inputted from a traveling control part 120 (which will be described later), and output a traveling driving force (torque) for the vehicle 1 to travel. In addition, in the case where the driving device 90 includes only the traveling motor, the motor ECU adjusts the duty ratio of the PWM signal given to the traveling motor according to the information inputted from the traveling control part 120, and outputs the traveling driving force described above. Further, in the case where the driving device 90 includes the engine and the traveling motor, the FI-ECU and the motor ECU control the traveling driving force in cooperation with each other according to the information inputted from the traveling control part 120.

The steering device 92 includes an electric motor, for example. For example, the electric motor changes the direction of the steerable wheels by applying a force to a rack and pinion mechanism. The steering device 92 drives the electric motor according to the information inputted from the traveling control part 120 to change the direction of the steerable wheels.

The brake device 94 is an electric servo brake device including brake calipers, a cylinder transmitting hydraulic pressure to the brake calipers, an electric motor generating the hydraulic pressure in the cylinder, and a braking control part, for example. The braking control part of the electric servo brake device controls the electric motor according to the information inputted from the traveling control part 120, so that a brake torque (braking force output device) for outputting a braking force corresponding to the braking operation is outputted to each wheel. The electric servo brake device may include a mechanism, which transmits the hydraulic pressure generated by the operation of the brake pedal 72 to the cylinder via a master cylinder, as a backup. Nevertheless, the brake device 94 is not limited to the electric servo brake device described above, and may be an electronically controlled hydraulic brake device. The electronically controlled hydraulic brake device controls an actuator according to the information inputted from the traveling control part 120 to transmit the hydraulic pressure of the master cylinder to the cylinder. In addition, if the driving device 90 includes the traveling motor, the brake device 94 may include a regenerative brake of the traveling motor.

Next, the control device 100 will be described. The control device 100 includes an automatic driving control part 110, the traveling control part 120, and the storage part 140. The automatic driving control part 110 includes an own vehicle position recognition part 112, an outside recognition part 114, an action plan generation part 116, and a target traveling state setting part 118. Each part of the automatic driving control part 110 and a part or all of the traveling control part 120 are realized by execution of a program performed by a processor such as a CPU (central processing unit). In addition, a part or all of these may be realized by hardware such as LSI (large scale integration) or ASIC (application specific integrated circuit). Further, the storage part 140 is realized by ROM (read only memory), RAM (random access memory), HDD (hard disk drive), flash memory, or the like. The program executed by the processor may be stored in the storage part 140 in advance or may be downloaded from an external device via an in-vehicle Internet facility or the like. Moreover, the program may be installed in the storage part 140 by mounting a portable storage medium that stores the program in a drive device (not shown). In addition, the control device 100 may be distributed by a plurality of computer devices. Thereby, various processes in the present embodiment can be realized by cooperating the above-mentioned hardware functional parts and software composed of programs with the in-vehicle computer of the vehicle 1.

The automatic driving control part 110 performs control by switching the driving mode according to input of the signal from the changeover switch 80. The driving modes include a driving mode (automatic driving mode) that automatically controls the acceleration, deceleration, and steering of the vehicle 1, and a driving mode (manual driving mode) that controls acceleration and deceleration of the vehicle 1 based on the operation on operation devices such as the accelerator pedal 70 and the brake pedal 72 and controls steering based on the operation on operation devices such as the steering wheel 74, but the driving modes are not limited thereto. As another driving mode, for example, a driving mode (semi-automatic driving mode) may be included, which controls one of the acceleration, deceleration, and steering of the vehicle 1 automatically and controls another based on the operation on the operation devices. In the following description, “automatic driving” includes the semi-automatic driving mode in addition to the above-mentioned automatic driving mode.

When implementing the manual driving mode, the automatic driving control part 110 may stop the operation, and the input signal from the operation detection sensor may be outputted to the traveling control part 120 or may be supplied directly to the driving device 90 (FI-ECU 241 or AT-ECU 242), the steering device 92, or the brake device 94.

The own vehicle position recognition part 112 of the automatic driving control part 110 recognizes the lane (traveling lane) on which the vehicle 1 is traveling, and the relative position of the vehicle 1 with respect to the traveling lane based on the map information 142 stored in the storage part 140, and the information inputted from the external condition acquisition part 12, the route information acquisition part 13, or the traveling state acquisition part 14. The map information 142 is, for example, map information with higher accuracy than the navigation map included in the route information acquisition part 13, and includes information of the center of the lane or information of the boundary of the lane. More specifically, the map information 142 includes road information, traffic regulation information, address information (address/postal code), facility information, telephone number information, or the like. The road information includes information indicating types of roads such as expressways, toll roads, national highways, and prefectural roads, or information of the number of lanes on the road, the width of each lane, the gradient of the road, the position of the road (three-dimensional coordinates including longitude, latitude, and height), the curvature of the curve of the lane, the positions of the junction and branch point of the lanes, the signs provided on the road, or the like. The traffic regulation information includes information that the lane is blocked due to construction, traffic accidents, traffic jam, or the like.

For example, the own vehicle position recognition part 112 recognizes a deviation of the reference point (for example, the center of gravity) of the vehicle 1 from the center of the traveling lane, and the angle formed with respect to the line connecting the center of the traveling lane in the traveling direction of the vehicle 1 as the relative position of the vehicle 1 with respect to the traveling lane. Nevertheless, instead of the above, the own vehicle position recognition part 112 may also recognize the position of the reference point of the vehicle 1 with respect to any side end portion of the own lane as the relative position of the vehicle 1 with respect to the traveling lane.

The outside recognition part 114 recognizes the position and the state such as speed, acceleration, etc., of a surrounding vehicle based on the information inputted from the external condition acquisition part 12, etc. The surrounding vehicle in the present embodiment is another vehicle that travels around the vehicle 1 and is a vehicle that travels in the same direction as the vehicle 1. The position of the surrounding vehicle may be represented by a representative point such as the center of gravity or a corner of the vehicle 1 or may be represented by a region presented by the outline of the vehicle 1. The “state” of the surrounding vehicle may include whether the surrounding vehicle is accelerating or changing lane (or whether the surrounding vehicle is about to change lane) based on the information of the above various machines. The outside recognition part 114 may also recognize the positions of guardrails, utility poles, parked vehicles, pedestrians, or other objects in addition to the surrounding vehicle.

The action plan generation part 116 sets a start point of automatic driving, a planned end point of automatic driving, and/or a destination of automatic driving. The start point of automatic driving may be the current position of the vehicle 1 or the point where the occupant of the vehicle 1 performs the operation of instructing automatic driving. The action plan generation part 116 generates an action plan in the section between the start point and the planned end point or in the section between the start point and the destination of automatic driving. Nevertheless, the disclosure is not limited thereto, and the action plan generation part 116 may generate an action plan for any section.

For example, the action plan is composed of a plurality of events that are to be executed sequentially. For example, the events include a deceleration event for decelerating the vehicle 1, an acceleration event for accelerating the vehicle 1, a lane keeping event for the vehicle 1 to travel without deviating from the traveling lane, a lane change event for changing the traveling lane, an overtaking event for the vehicle 1 to overtake the preceding vehicle, a branch event for the vehicle 1 to change to a desired lane at a branch point or to travel with deviating from the current traveling lane, a junction event for accelerating or decelerating the vehicle 1 and changing the traveling lane in a merging lane so as to join the main lane, or the like. For example, when a junction (branch point) is present on a toll road (for example, an expressway), the control device 100 changes the lane or maintains the lane for the vehicle 1 to travel in the direction of the destination. Therefore, when it is decided that a junction is present on the route with reference to the map information 142, the action plan generation part 116 sets a lane change event for changing the lane to a desired lane, by which the vehicle 1 can travel in the direction of the destination, between the current position (coordinates) of the vehicle 1 and the position (coordinates) of the junction. The information indicating the action plan generated by the action plan generation part 116 is stored in the storage part 140 as action plan information 146.

The target traveling state setting part 118 is configured to set a target traveling state, which is a traveling state targeted by the vehicle 1, based on the action plan determined by the action plan generation part 116 and various types of information acquired by the external condition acquisition part 12, the route information acquisition part 13, and the traveling state acquisition part 14. The target traveling state setting part 118 includes a target value setting part 52 and a target trajectory setting part 54. The target traveling state setting part 118 also includes a deviation acquisition part 42 and a correction part 44.

The target value setting part 52 is configured to set information of the traveling position (latitude, longitude, altitude, coordinates, etc.) targeted by the vehicle 1 (simply referred to as the target position), target value information of the vehicle speed (simply referred to as the target vehicle speed), and target value information of the yaw rate (simply referred to as the target yaw rate). The target trajectory setting part 54 is configured to set information of the target trajectory of the vehicle 1 (simply referred to as the target trajectory) based on the external condition acquired by the external condition acquisition part 12 and the traveling route information acquired by the route information acquisition part 13. The target trajectory includes information of the target position for each unit time. Attitude information (traveling direction) of the vehicle 1 is associated with each target position. In addition, target value information such as the vehicle speed, acceleration, yaw rate, lateral G, steering angle, steering angle speed, steering angle acceleration, or the like may be associated with each target position. The above target position, target vehicle speed, target yaw rate, and target trajectory are information indicating the target traveling state.

The deviation acquisition part 42 is configured to acquire a deviation of the actual traveling state with respect to the target traveling state based on the target traveling state set by the target traveling state setting part 118 and the actual traveling state acquired by the traveling state acquisition part 14.

The correction part 44 is configured to correct the target traveling state according to the deviation acquired by the deviation acquisition part 42. Specifically, as the deviation increases, the target traveling state set by the target traveling state setting part 118 is brought closer to the actual traveling state acquired by the traveling state acquisition part 14 to set a new target traveling state.

The traveling control part 120 is configured to control the traveling of the vehicle 1. Specifically, a command value of traveling control is outputted to make the traveling state of the vehicle 1 coincide with or close to the target traveling state set by the target traveling state setting part 118 or the new target traveling state set by the correction part 44. The traveling control part 120 includes an acceleration/deceleration command part 56 and a steering command part 58.

The acceleration/deceleration command part 56 is configured to perform acceleration/deceleration control in the traveling control of the vehicle 1. Specifically, the acceleration/deceleration command part 56 calculates an acceleration/deceleration command value for making the traveling state of the vehicle 1 coincide with the target traveling state based on the target traveling state (target acceleration/deceleration) set by the target traveling state setting part 118 or the correction part 44 and the actual traveling state (actual acceleration/deceleration).

The steering command part 58 is configured to perform steering control in the traveling control of the vehicle 1. Specifically, the steering command part 58 calculates a steering angle speed command value for making the traveling state of the vehicle 1 coincide with the target traveling state based on the target traveling state set by the target traveling state setting part 118 or the correction part 44 and the actual traveling state.

FIG. 2 is a schematic diagram showing a configuration of the driving device 90 of the vehicle 1. As shown in FIG. 2, the driving device 90 of the vehicle 1 of the present embodiment includes the engine 203 mounted horizontally on the front portion of the vehicle 1, the automatic transmission 204 installed integrally with the engine 203, and a driving torque transmission path 220 for transmitting the driving torque from the engine 203 to front left and right wheels (hereinafter referred to as “front wheels”) Wf1 and Wf2 and rear left and right wheels (hereinafter referred to as “rear wheels”) Wr1 and Wr2.

The output shaft (not shown) of the engine 203 is connected to the left and right front wheels Wf1 and Wf2, which are the main drive wheels, via the automatic transmission 204, a front differential (hereinafter referred to as “front differential”) 205, and left and right front drive shafts 206. Further, the output shaft of the engine 203 is connected to the rear wheels Wr1 and Wr2, which are the auxiliary drive wheels, via the automatic transmission 204, the front differential 205, a propeller shaft 207, a rear differential unit 208, and left and right rear drive shafts 209.

The rear differential unit 208 is provided with a rear differential 219 for distributing the driving torque to the left and right rear drive shafts 209, and a front and rear torque distribution clutch (driving force distribution control part) 210 for connecting/disconnecting a driving torque transmission path from the propeller shaft 207 to the rear differential 219. The front and rear torque distribution clutch 210 is a hydraulic clutch for controlling the driving torque distributed to the rear wheels Wr1 and Wr2 in the driving torque transmission path 220. In addition, a hydraulic circuit 230 for supplying hydraulic oil to the front and rear torque distribution clutch 210, and a 4WD ECU (driving force distribution control part) 250, which is a control part for controlling the supply oil pressure of the hydraulic circuit 230, are provided. The control unit 250 is constituted by a microcomputer or the like.

The 4WD ECU 250 controls the supply oil pressure of the hydraulic circuit 230 to control the driving force distributed to the rear wheels Wr1 and Wr2 by the front and rear torque distribution clutch 210. Thus, driving control is performed with the front wheels Wf1 and Wf2 as the main drive wheels and the rear wheels Wr1 and Wr2 as the auxiliary drive wheels.

That is, when the front and rear torque distribution clutch 210 is released (disconnected), the rotation of the propeller shaft 207 is not transmitted to the side of the rear differential 219, and all the torque of the engine 203 is transmitted to the front wheels Wf1 and Wf2, so that the vehicle 1 enters the front-wheel drive (2WD) state. On the other hand, when the front and rear torque distribution clutch 210 is engaged (connected), the rotation of the propeller shaft 207 is transmitted to the side of the rear differential 219, so that the torque of the engine 203 is distributed to both the front wheels Wf1 and Wf2 and the rear wheels Wr1 and Wr2 to enter the four-wheel drive (4WD) state. Based on the detection of various detection part (not shown) for detecting the traveling state of the vehicle, the 4WD ECU 250 calculates the driving force to be distributed to the rear wheels Wr1 and Wr2 and the oil pressure supply amount to the front and rear torque distribution clutch 210 corresponding thereto, and outputs a driving signal based on the calculation result to the front and rear torque distribution clutch 210. Thereby, the engaging force of the front and rear torque distribution clutch 210 is controlled to control the driving force distributed to the rear wheels Wr1 and Wr2.

### [Overview of Manual Driving Control]

In the vehicle 1, when the manual driving mode is selected, the driver performs the control (acceleration, deceleration, and steering control) of the vehicle 1 based on a conventional operation, not via the automatic driving control part 110. In the manual driving mode, the detection information of the accelerator opening degree sensor 71 which is the operation detection sensor is directly inputted to the control part (not shown) which controls the engine 203 and the automatic transmission 204 of the driving device 90, and the control part controls the engine 203 and the automatic transmission 204 based on the detection information. Further, the brake device 94 is controlled based on the detection information of the brake depression amount sensor 73. By these, the acceleration and deceleration of the vehicle 1 are controlled. In addition, the steering device 92 is controlled based on the detection information of the steering angle sensor 75. Thereby, steering of the vehicle 1 is performed.

### [Overview of Automatic Driving Control]

In the vehicle 1, when the automatic driving mode is selected by the driver's operation of the changeover switch 80, the automatic driving control part 110 performs automatic driving control of the vehicle 1. In the automatic driving control, the automatic driving control part 110 determines the current traveling state (actual traveling trajectory, traveling position, etc.) of the vehicle 1 based on the information acquired from the external condition acquisition part 12, the route information acquisition part 13, the traveling state acquisition part 14, etc. or the information recognized by the own vehicle position recognition part 112 and the outside recognition part 114. The target traveling state setting part 118 sets the target traveling state (target trajectory and target position), which is the traveling state targeted by the vehicle 1, based on the action plan generated by the action plan generation part 116. The deviation acquisition part 42 acquires the deviation of the actual traveling state with respect to the target traveling state. When the deviation is acquired by the deviation acquisition part 42, the traveling control part 120 performs traveling control so as to make the traveling state of the vehicle 1 coincide with or close to the target traveling state.

The correction part 44 corrects the target trajectory or the target position based on the traveling position acquired by the traveling position acquisition part 26. The traveling control part 120 controls acceleration and deceleration of the vehicle 1 by the driving device 90 and the brake device 94 based on the vehicle speed, etc. acquired by the vehicle speed acquisition part for the vehicle 1 to follow the new target trajectory or target position.

The correction part 44 also corrects the target trajectory based on the traveling position acquired by the traveling position acquisition part 26. The traveling control part 120 performs steering control by the steering device 92 based on the steering angle speed acquired by the steering angle acquisition part 32 for the vehicle 1 to follow the new target trajectory.

### [Control for Rut Traveling]

Then, in the control device 100 of the vehicle 1 of the present embodiment, whether a rut is present on the road surface ahead in the traveling direction of the vehicle 1 is determined during traveling of the vehicle 1 in the above-described automatic driving mode or manual driving mode, and when the determination changes between “a rut is present” and “no rut is present”, control (hereinafter referred to as “rut traveling control”) is performed for changing the driving force distribution for the front wheels Wf1 and Wf2 and the rear wheels Wr1 and Wr2 by the front and rear torque distribution clutch 210. Details of the configuration and control for the rut traveling control will be described hereinafter.

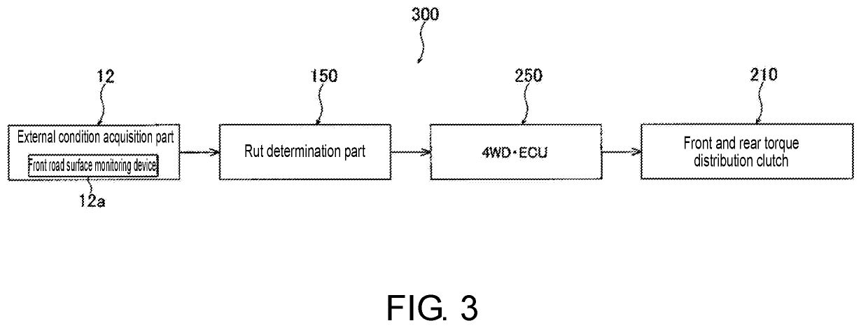

The vehicle 1 of the present embodiment is provided with a rut traveling control device 300 for performing the above-mentioned rut traveling control. FIG. 3 is a block diagram showing a schematic configuration of the rut traveling control device 300. As shown in FIG. 3, the rut traveling control device 300 includes the external condition acquisition part (road surface information acquisition part) 12 for acquiring road surface information ahead in the traveling direction of the vehicle 1, a rut determination part 150 for performing rut determination to determine whether a rut is present on the road surface ahead in the traveling direction of the vehicle 1 based on the road surface information acquired by the external condition acquisition part 12, the 4WD ECU (driving force distribution control part) 250 for controlling the front and rear torque distribution clutch 210 based on the determination of whether a rut is present made by the rut determination part 150, and the front and rear torque distribution clutch (driving force distribution control part) 210 for controlling the driving force (torque) distributed to the front wheels Wf1 and Wf2 and the rear wheels Wr1 and Wr2 based on the control signal from the 4WD ECU 250. As described above, the external condition acquisition part 12 includes the front road surface monitoring device 12a including the camera and radar shown in FIG. 1, and the rut determination part 150 is configured as a part of the function of the control device 100 shown in FIG. 1.

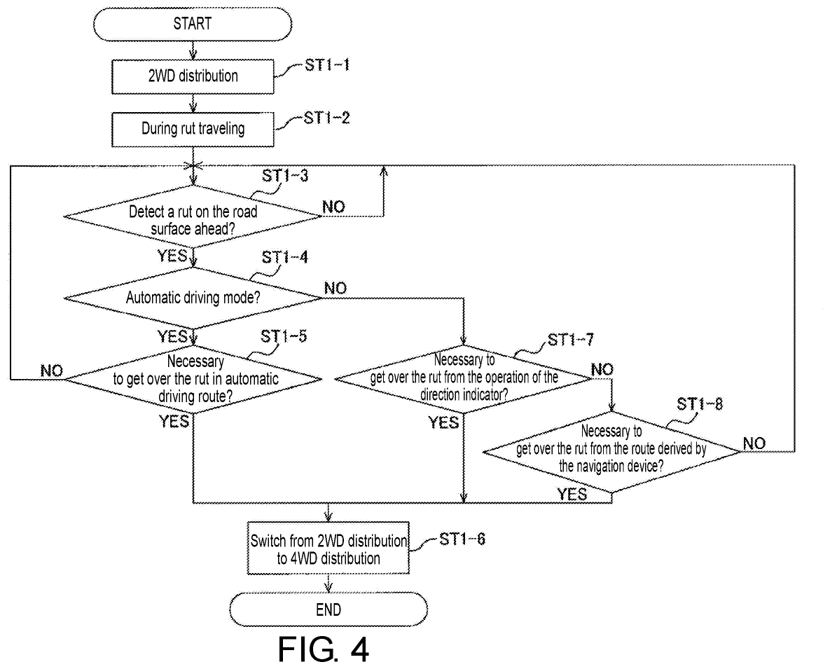

FIG. 4 is a flowchart for illustrating a procedure of the rut traveling control. The procedure of the rut traveling control will be described with reference to the flowchart of FIG. 4. Here, first, the distribution of the driving force of the vehicle 1 is 2WD (front-wheel drive) distribution (step ST1-1), and under the condition that the vehicle 1 is traveling in the rut (traveling along the rut) in this state (step ST1-2), whether a rut is present on the road surface ahead in the traveling direction of the vehicle 1 (whether the traveled rut continues further) is determined (rut determination) (step ST1-3). The rut determination is performed based on the road surface information ahead in the traveling direction of the vehicle 1 acquired by the front road surface monitoring device 12a. As a result, when it is determined that no rut is present (NO), step ST1-3 of the rut determination is repeated, but when it is determined that a rut is present (YES), it is subsequently determined whether the traveling mode of the vehicle 1 is the automatic driving mode (step ST1-4). As a result, if the traveling mode is the automatic driving mode (YES), it is subsequently determined whether it is necessary to get over the detected rut when traveling on the traveling route of the vehicle 1 determined by the automatic driving control part 110 (step ST1-5). Specifically, for example, in the case where the vehicle 1 is traveling straight along a substantially straight rut, if it is decided that the vehicle 1 will be out of the rut by making a change in course such as a left turn or a right turn on the traveling route of the automatic driving mode, it is determined necessary to get over the rut. On the other hand, if it is decided that the vehicle 1 will continue traveling along the rut by continuing traveling straight on the traveling route of the automatic driving mode, it is determined not necessary to get over the rut. As a result, when it is determined necessary to get over the rut (YES), the front and rear torque distribution clutch 210 is controlled via the 4WD ECU 250 to switch the distribution of the driving force of the vehicle 1 from 2WD distribution to 4WD distribution (step ST1-6). On the other hand, when it is determined not necessary to get over the rut (NO), the procedure returns to step ST1-3 to repeat the determination of whether a rut is present.

However, if it is determined in the preceding step ST1-4 that the traveling mode is not the automatic driving mode (NO), it is subsequently determined whether it is necessary to get over the detected rut based on the operation of the direction indicator 84 performed by the driver of the vehicle 1 (step ST1-7). For example, in the case where the vehicle 1 is traveling straight along a substantially straight rut, if it is decided that the vehicle 1 will be out of the rut by making a change in course such as a left turn or a right turn according to the operation of the direction indicator 84 performed by the driver, it is determined necessary to get over the rut. On the other hand, if it is decided that the driver does not operate the direction indicator 84 and the vehicle 1 will continue traveling along the rut by continuing traveling straight, it is determined not necessary to get over the rut. As a result, when it is determined necessary to get over the rut (YES), the distribution of the driving force of the vehicle 1 is switched from 2WD distribution to 4WD distribution (step ST1-6). On the other hand, when it is determined not necessary to get over the rut (NO), it is subsequently determined whether it is necessary to get over the detected rut based on the traveling route of the vehicle 1 derived by the navigation device 13a (step ST1-8). For example, in the case where the vehicle 1 is traveling straight along a substantially straight rut, if it is decided that the vehicle 1 will be out of the rut by making a change in course such as a left turn or a right turn according to the traveling route of the vehicle 1 derived by the navigation device 13a, it is determined necessary to get over the rut. On the other hand, if it is decided that the vehicle 1 will continue traveling along the rut by continuing traveling straight according to the traveling route of the vehicle 1 derived by the navigation device 13a, it is determined not necessary to get over the rut. As a result, when it is determined necessary to get over the rut (YES), the distribution of the driving force of the vehicle 1 is switched from 2WD distribution to 4WD distribution (step ST1-6). On the other hand, when it is determined not necessary to get over the rut (NO), the procedure returns to step ST1-3 to repeat the determination of whether a rut is present.

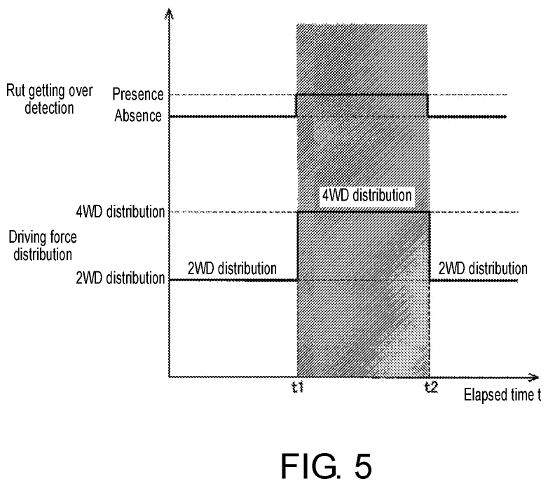

FIG. 5 is a timing chart showing the change of each value in the above-mentioned rut traveling control. The timing chart (graph) of FIG. 5 shows presence/absence of the rut getting over detection with respect to the elapsed time t and the change between 2WD distribution and 4WD distribution in the driving force distribution control. In the timing chart of FIG. 5, the rut getting over detection changes from “absence” to “presence” at the time t1, by which the driving force distribution of the driving force distribution control changes from 2WD distribution, which has been adopted so far, to 4WD distribution. Thereby, the vehicle 1 gets over the rut in the 4WD traveling state. Thereafter, when the vehicle 1 completes getting over the rut and the rut getting over detection becomes “absence” at the time t2, the driving force distribution of the driving force distribution control changes from 4WD distribution to 2WD distribution. As shown in the timing chart, when the rut getting over detection changes between presence and absence, the driving force distribution of the driving force distribution control changes between 2WD distribution and 4WD distribution. Thus, it is possible to get over the rut smoothly.

As described above, in the control device of the vehicle of the present embodiment, when the determination made by the rut determination part 150 changes between “a rut is present” and “no rut is present”, the 4WD ECU 250 and the front and rear torque distribution clutch 210, which are the driving force distribution control part, perform control to change the driving force distribution for the front wheels Wf1 and Wf2 and the rear wheels Wr1 and Wr2 of the vehicle 1. Thereby, when the vehicle 1 deviates from a rut in a state of traveling along the rut, or when the vehicle 1 enters a rut from outside, the driving force for the front wheels Wf1 and Wf2 and the rear wheels Wr1 and Wr2 can be distributed properly and the vehicle 1 can smoothly get over the rut. Therefore, it is possible to secure good traveling performance of the vehicle 1.

Moreover, in this case, when the traveling mode of the vehicle 1 is the manual driving mode, whether a rut is present may be determined based on the operation of the direction indicator 84 performed by the driver. Alternatively, whether a rut is present may be determined based on the traveling route of the vehicle 1 acquired by the navigation device 13a. According to these, in the manual driving mode, the traveling direction of the vehicle 1 can be grasped in advance, and it is possible to accurately determine whether a rut is present on the road surface ahead in the traveling direction. Therefore, it is possible to get over the rut more smoothly.

Furthermore, when the traveling mode of the vehicle 1 is the automatic driving mode, by determining whether a rut is present based on the traveling route of the vehicle 1 determined by the automatic driving control part 110, the traveling direction of the vehicle 1 can be grasped in advance, and it is possible to accurately determine whether a rut is present on the road surface ahead in the traveling direction. Therefore, it is possible to get over the rut more smoothly.

Although embodiments of the disclosure have been described above, the disclosure is not limited to the above embodiments, and it is possible to make various modifications within the scope of the claims and the scope of the technical ideas described in the specification and drawings. For example, the automatic driving mode at the time when the above-mentioned rut traveling control is executed is for automatically controlling both the steering angle and the acceleration and deceleration of the vehicle 1. However, in addition thereto, the driving mode at the time when the rut traveling control is executed may be the semi-automatic driving mode for automatically controlling only acceleration and deceleration of the vehicle 1. In that case, as in the manual driving mode, whether a rut is present may be determined based on the operation of the direction indicator 84 performed by the driver or the route acquired by the navigation device 13a.

Further, in the above embodiment, the driving device 90 of the vehicle 1 is configured to perform front and rear distribution control for distributing the driving force of the engine 3 to the front wheels Wf1 and Wf2 and the rear wheels Wr1 and Wr2 by the front and rear torque distribution clutch 210. However, the manner of controlling the distribution of the driving force to a plurality of wheels by the driving device 90 of the vehicle 1 of the disclosure is not limited thereto. In addition to the above, for example, in a configuration that can distribute the driving force to the left and right wheels of the vehicle (left and right distribution control), control may be performed to distribute the driving force from the drive source to the left wheel and the right wheel.

Further, the above embodiment illustrates that when front and rear distribution control is performed, control is performed to switch between the driving force distribution to only the front wheels Wf1 and Wf2 (2WD state) and the driving force distribution to the front wheels Wf1 and Wf2 and the rear wheels Wr1 and Wr2 (4WD state). However, in addition to completely switching between the 2WD state and the 4WD state, control may be performed to change the distribution amount (ratio) of the driving force to the rear wheels Wr1 and Wr2.

What is claimed is:

1. A control device for a vehicle, comprising a driving force distribution control part that controls a distribution of a driving force from a drive source to a plurality of wheels, the control device for the vehicle comprising:
a road surface information acquisition part acquiring a road surface information ahead in a traveling direction of the vehicle; and
a rut determination part performing a rut determination to determine whether a rut is present on a road surface ahead in the traveling direction of the vehicle based on the road surface information acquired by the road surface information acquisition part,
wherein the driving force distribution control part performs a control to change the distribution of the driving force to the wheels when the determination made by the rut determination part changes between that a rut is present and that no rut is present.

2. The control device for the vehicle according to claim 1, comprising:
a direction indicator by which the traveling direction of the vehicle is indicated by an operation of a driver of the vehicle,
wherein the rut determination part performs the rut determination based on the operation of the direction indicator performed by the driver.

3. The control device for the vehicle according to claim 1, comprising:
a navigation device having a function of acquiring information from outside to identify a position of the vehicle and deriving a route from the position to a destination,
wherein the rut determination part performs the rut determination based on a traveling route of the vehicle derived by the navigation device.

4. The control device for the vehicle according to claim 1, comprising:
an automatic driving control part performing an automatic driving control that automatically controls at least one of acceleration, deceleration, and steering of the vehicle,
wherein the rut determination part performs the rut determination based on a traveling route of the vehicle determined by the automatic driving control part.

5. The control device for the vehicle according to claim 1, wherein the driving force distribution control part is capable of switching the distribution of the driving force of the vehicle between a two-wheel drive state and a four-wheel drive state, and
when the determination made by the rut determination part changes between that a rut is present and that no rut is present, a control is performed to switch the distribution of the driving force between the two-wheel drive state and the four-wheel drive state.

6. The control device for the vehicle according to claim 2, wherein the driving force distribution control part is capable of switching the distribution of the driving force of the vehicle between a two-wheel drive state and a four-wheel drive state, and
when the determination made by the rut determination part changes between that a rut is present and that no rut is present, a control is performed to switch the distribution of the driving force between the two-wheel drive state and the four-wheel drive state.

7. The control device for the vehicle according to claim 3, wherein the driving force distribution control part is capable of switching the distribution of the driving force of the vehicle between a two-wheel drive state and a four-wheel drive state, and
when the determination made by the rut determination part changes between that a rut is present and that no rut is present, a control is performed to switch the distribution of the driving force between the two-wheel drive state and the four-wheel drive state.

8. The control device for the vehicle according to claim 1, wherein the road surface information acquisition part comprises an imaging device that captures an image of the road surface ahead in the traveling direction of the vehicle, and
the rut determination part performs the rut determination based on the image captured by the imaging device.

9. The control device for the vehicle according to claim 2, wherein the road surface information acquisition part comprises an imaging device that captures an image of the road surface ahead in the traveling direction of the vehicle, and
the rut determination part performs the rut determination based on the image captured by the imaging device.

10. The control device for the vehicle according to claim 3, wherein the road surface information acquisition part comprises an imaging device that captures an image of the road surface ahead in the traveling direction of the vehicle, and
the rut determination part performs the rut determination based on the image captured by the imaging device.

11. The control device for the vehicle according to claim 4, wherein the road surface information acquisition part comprises an imaging device that captures an image of the road surface ahead in the traveling direction of the vehicle, and
the rut determination part performs the rut determination based on the image captured by the imaging device.
